(19) United States
(12) Patent Application Publication
(10) Pub. No.: US 2026/0094540 A1
(43) Pub. Date: Apr. 2, 2026

(54) Planetary Learning Device

(71) Applicant: Rebecca Davis, Bethel Park, PA (US)

(72) Inventor: Rebecca Davis, Bethel Park, PA (US)

(21) Appl. No.: 19/087,793

(22) Filed: Mar. 24, 2025

Related U.S. Application Data
(60) Provisional application No. 63/699,864, filed on Sep. 27, 2024.

(51) Int. Cl. G09B 27/00; G09B 5/06

(52) U.S. Cl. CPC G09B 27/00; G09B 5/065

(57) ABSTRACT

A planetary learning device is provided. The device is comprised of a body that may take various geometric shapes resembling celestial objects, such as planets or stars, and may incorporate phosphorescent materials and LEDs for simulating natural celestial phenomena. The device also includes at least one speaker for providing audio content related to the celestial object, with facts or scientific data being played via a removable memory card or streamed wirelessly. The body can be charged through a docking station, which may include a rotating platform to simulate planetary motion. Additionally, the device features sensors for interactive functionality and may include an augmented reality application for enhanced learning. A vibration motor can further simulate seismic activity or gravitational forces, offering an immersive educational experience.

### CROSS-REFERENCE TO RELATED APPLICATION

The present application claims priority to, and the benefit of, U.S. Provisional Application No. 63/699,864, which was filed on Sep. 27, 2024, and is incorporated herein by reference in its entirety.

### FIELD OF THE INVENTION

The present invention relates generally to the field of education devices. More specifically, the present invention relates to a planetary learning device that provides a simulative planet with interactive audio. Accordingly, the present disclosure makes specific reference thereto. Nonetheless, it is to be appreciated that aspects of the present invention are also equally applicable to other like applications, devices, and methods of manufacture.

### BACKGROUND

Children often seek engaging and interactive ways to explore and learn about planets, stars, and the solar system. By incorporating fun, hands-on activities, colorful visuals, and exciting technology like augmented reality or interactive apps, they can deepen their understanding of astronomy while staying entertained. Whether through games, storytelling, or interactive models of planets and space, these methods can stimulate curiosity and foster a lasting interest in space science. Creating a learning experience that combines education with play can make complex topics like the solar system more accessible and enjoyable for young minds.

Therefore, there exists a long-felt need in the art for an educational device for planetary education. There also exists a long-felt need in the art for a planetary learning device. More specifically, there exists a long-felt need in the art for a planetary learning device that educates children about planets, moons, exoplanets, stars, etc. Further, there exists a long-felt need in the art for a planetary learning device that educates children about planets, moons, exoplanets, stars, etc., in an interactive and non-traditional manner.

The subject matter disclosed and claimed herein, in one embodiment thereof, comprises a planetary learning device. The device is comprised of a body that may take various geometric shapes resembling celestial objects, such as planets or stars, and may incorporate phosphorescent materials and LEDs for simulating natural celestial phenomena. The device also includes at least one speaker for providing audio content related to the celestial object, with facts or scientific data being played via a removable memory card or streamed wirelessly. The body can be charged through a docking station, which may include a rotating platform to simulate planetary motion. Additionally, the device features sensors for interactive functionality and may include an augmented reality application for enhanced learning. A vibration motor can further simulate seismic activity or gravitational forces, offering an immersive educational experience.

In this manner, the planetary learning device of the present invention accomplishes all the foregoing objectives and provides an educational device for planetary education. More specifically, the device provides a learning device that educates children about planets, moons, exoplanets, stars, etc. Further, the device does so in an interactive and non-traditional manner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a planetary learning device. The device is comprised of a body that may be shaped and colored to resemble any planet, star, moon, exoplanet, asteroid, or comet. In one embodiment, the body is comprised of a phosphorescent material, allowing the body to glow in the dark, simulating the appearance of a celestial body at night. Additionally, the body may include at least one embedded LED light that can dynamically change color and intensity to represent different stages of a star's life cycle or planetary atmospheres, enhancing the educational experience. The body may be comprised of at least one speaker that produces audio. The audio is preferably spoken word that informs a user about facts, trivia, scientific data, historical information, etc., regarding the planet, star, moon, exoplanet, or other celestial body the body resembles in order to teach and inform the user about the same.

The body is further comprised of at least one charging port that allows the speaker and other electronic components within the body to charge via at least one charging port of a docking station. The docking station may also serve as a base for displaying the body, and may include additional features, such as a rotating platform that turns the body slowly to simulate the rotation of a planet or moon. This adds a visual element to the learning experience. The platform may be rotated by at least one motor.

In one embodiment, the device further includes at least one sensor integrated into the body. The sensor can detect motion, proximity, or light levels and can activate different features of the device accordingly. For example, the sensor can activate the speaker or the LED lights when someone approaches the device or when it gets dark, enhancing the user interaction and experience. Additionally, the sensor may be configured to detect ambient sound levels and adjust the volume of the speaker accordingly.

In another embodiment, the body is equipped with at least one vibration motor 146, which can simulate the feel of seismic activity or gravitational forces, depending on the celestial body being represented. This motor can activate when specific audio or educational content is played, further immersing the user in the educational experience.

Accordingly, the planetary learning device of the present invention is particularly advantageous as it provides an educational device for planetary education. More specifically, the device provides a learning device that educates children about planets, moons, exoplanets, stars, etc. Further, the device does so in an interactive and non-traditional manner. In this manner, the planetary learning device provides a novel educational tool for planetary education.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of a body of one potential embodiment of a planetary learning device of the present invention in accordance with the disclosed architecture; and

FIG. 2 illustrates a front view of a docking station of one potential embodiment of a planetary learning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an educational device for planetary education. There also exists a long-felt need in the art for a planetary learning device. More specifically, there exists a long-felt need in the art for a planetary learning device that educates children about planets, moons, exoplanets, stars, etc. Further, there exists a long-felt need in the art for a planetary learning device that educates children about planets, moons, exoplanets, stars, etc., in an interactive and non-traditional manner.

The present invention, in one exemplary embodiment, is comprised of a planetary learning device. The device includes a body that can be shaped and colored to resemble a planet, star, moon, exoplanet, asteroid, or comet. In one embodiment, the body is made of a phosphorescent material, allowing it to glow in the dark, mimicking the appearance of a celestial body at night. Additionally, the body may contain at least one embedded LED light capable of dynamically changing color and intensity to represent different stages of a star's life cycle or planetary atmospheres, enhancing the learning experience. The body may also feature at least one speaker that produces audio, preferably spoken word, providing information on facts, trivia, scientific data, historical information, and more about the celestial body it represents, thereby educating the user.

The body further includes at least one charging port that allows the speaker and other electronic components to recharge via a charging port on a docking station. The docking station can also serve as a display base for the body and may include features such as a rotating platform that slowly turns the body to simulate planetary or lunar rotation, adding a visual element to the educational experience. The platform's rotation may be driven by at least one motor.

In one embodiment, the device includes at least one sensor integrated into the body. This sensor can detect motion, proximity, or light levels and activate various features of the device accordingly. For example, the sensor might trigger the speaker or LED lights when someone approaches the device or when it gets dark, enriching the user's interaction and experience. Additionally, the sensor may detect ambient sound levels and adjust the speaker's volume accordingly.

In another embodiment, the body contains at least one vibration motor that can simulate seismic activity or gravitational forces, depending on the celestial body being represented. This motor can activate during specific audio or educational content, further immersing the user in the learning experience.

Therefore, the planetary learning device described herein offers significant advantages as an educational tool for teaching planetary concepts. Specifically, the device provides an interactive and non-traditional approach to educating children about planets, moons, stars, exoplanets, and more. In doing so, it presents a unique and innovative educational resource.

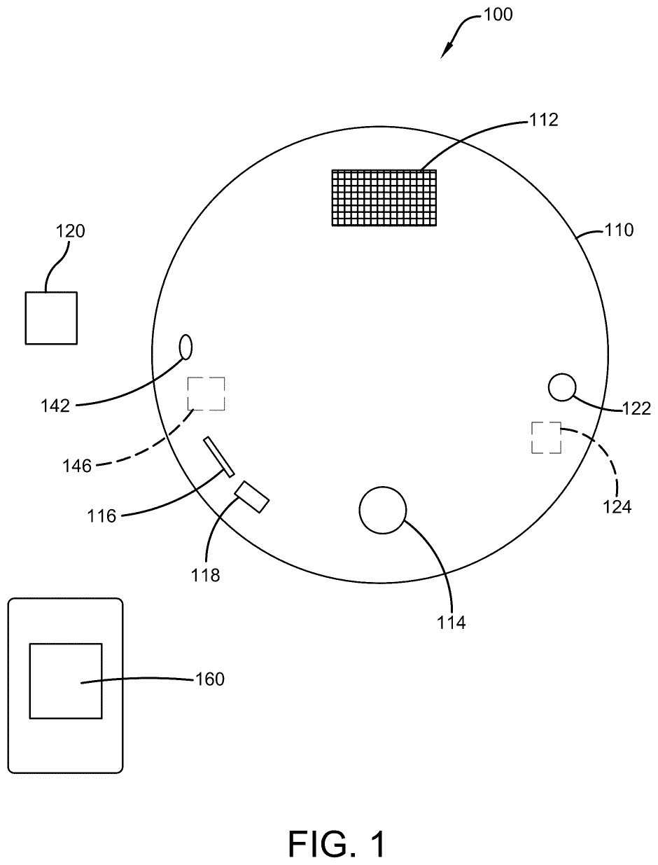

Referring initially to the drawings, FIG. 1 illustrates a front view of a body of one potential embodiment of a planetary learning device 100 of the present invention in accordance with the disclosed architecture. The device 100 is comprised of a body 110. The body 110 is preferably spherical, but in alternate embodiments the body may have other geometric shapes, such as ovoid or polyhedral, to resemble celestial objects. The body 110 may be shaped and colored to resemble any planet, star, moon, exoplanet, asteroid, or comet. In one embodiment, the body 110 is comprised of a phosphorescent material, allowing the body 110 to glow in the dark, simulating the appearance of a celestial body at night. The phosphorescence can be varied to mimic different natural phenomena, such as the phases of the moon or the luminosity of stars. Additionally, the body 110 may include at least one embedded LED light 122 that can dynamically change color and intensity to represent different stages of a star's life cycle or planetary atmospheres, enhancing the educational experience.

The body 110 may be comprised of at least one speaker 112. The speaker 112 produces audio, and in certain embodiments, it may provide surround sound for an immersive experience. In one embodiment, the audio is spoken word that informs a user about facts, trivia, scientific data, historical information, etc., regarding the planet, star, moon, exoplanet, or other celestial body the body 110 resembles in order to teach and inform the user about the same. In one embodiment, the speaker 112 is activated via pressing at least one button 114 on the body 110. The button 114 may be touch-sensitive or pressure-sensitive for ease of use. Different facts, trivia, etc., can be uploaded and played to the speaker via inserting at least one removable memory card 120 into the body 110 via at least one memory card opening 116. The memory card 120 may be of various types, such as microSD or USB, depending on the embodiment, allowing for extensive storage of data and audio files. In a further embodiment, the device 100 may include at least one wireless transmitter 124, such as Bluetooth or Wi-Fi, allowing the device 100 to receive updates remotely or stream audio from an external device or server.

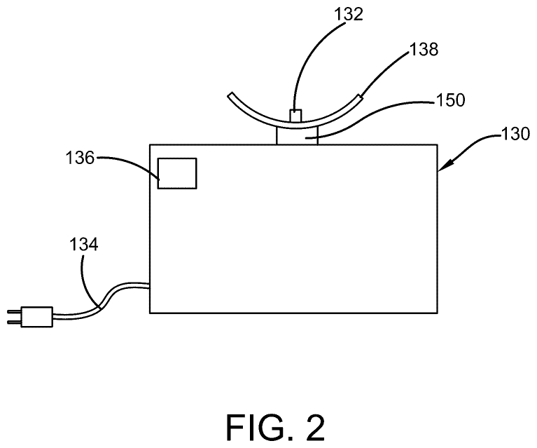

The body 110 is further comprised of at least one charging port 118. The charging port 118 allows the speaker 112 and other electronic components within the body 110 to charge via at least one charging port 132 of a docking station 130, as seen in FIG. 2. The charging ports 118, 132 are preferably any type of reciprocal charging ports known in the art, such as USB-C, Lightning, or wireless induction charging systems. The docking station 130 may receive power via at least one power cord 134 or, in another embodiment, may be solar-powered, incorporating at least one solar panel 136. The docking station 130 may also serve as a base for displaying the body 110, and may include additional features, such as a rotating platform 138 that turns the body 110 slowly to simulate the rotation of a planet or moon. This adds a visual element to the learning experience. The platform 138 may be rotated by at least one motor 150. In one embodiment, the body 110 is powered by at least one rechargeable or replaceable battery 170.

In one embodiment, the device 100 further includes at least one sensor 142 integrated into the body 110. The sensor 142 can detect motion, proximity, or light levels and can activate different features of the device accordingly. For example, the sensor 142 can activate the speaker 112 or the LED lights 122 when someone approaches the device or when it gets dark, enhancing the user interaction and experience. Additionally, the sensor 142 may be configured to detect ambient sound levels and adjust the volume of the speaker 112 accordingly.

The device 100 may further include an augmented reality (AR) mobile application 160 that allows a user to interact with the body 110, wherein pointing a phone or tablet at the body 110 could generate an augmented display of additional information, 3D models, or simulations related to the celestial body the device represents.

In another embodiment, the body 110 is equipped with at least one vibration motor 146, which can simulate the feel of seismic activity or gravitational forces, depending on the celestial body being represented. This motor can activate when specific audio or educational content is played, further immersing the user in the educational experience. For instance, when learning about earthquakes on the moon or other planetary bodies, the device could vibrate to simulate the sensation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “planetary learning device” and “device” are interchangeable and refer to the planetary learning device 100 of the present invention.

Notwithstanding the foregoing, the planetary learning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the planetary learning device 100 as shown in the FIGS. are for illustrative purposes only, and that many other sizes and shapes of the planetary learning device 100 are well within the scope of the present disclosure. Although the dimensions of the planetary learning device 100 are important design parameters for user convenience, the planetary learning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A planetary learning device comprising:
a body shaped to resemble a celestial object, the body comprised of a phosphorescent material;
an LED light embedded in the body;
a speaker integrated into the body, wherein the speaker is configured to produce an audio related to the celestial object the body resembles; and
a memory card opening in the body, configured to receive a removable memory card for storing and playing the audio through the speaker.

2. The planetary learning device of claim 1, wherein the body is comprised of a spherical, an ovoid, or a polyhedral shape.

3. The planetary learning device of claim 1 further comprised of a button that activates the speaker.

4. The planetary learning device of claim 3, wherein the button is comprised of a touch-sensitive button.

5. The planetary learning device of claim 3, wherein the button is comprised of a pressure-sensitive button.

6. The planetary learning device of claim 1, wherein the memory card is comprised of a USB memory card.

7. The planetary learning device of claim 1, wherein the memory card is comprised of a microSD memory card.

8. A planetary learning device comprising:
a body shaped to resemble a celestial object;
a sensor integrated into the body, wherein the sensor is configured to detect a motion, a proximity, or an ambient light and activate a feature of the device based on the detection;
an LED light embedded in the body configured to dynamically change color and intensity;
a speaker integrated into the body, configured to produce an audio related to the celestial object the body resembles; and
a wireless transmitter configured.

9. The planetary learning device of claim 8, wherein the sensor is configured to activate the LED light or the speaker when the sensor detects a motion or a proximity.

10. The planetary learning device of claim 8 further comprised of an augmented reality mobile application.

11. The planetary learning device of claim 8, wherein the transmitter is comprised of a Bluetooth transmitter.

12. The planetary learning device of claim 8, wherein the transmitter is comprised of a Wi-Fi transmitter.

13. A planetary learning device comprising:
a body shaped to resemble a celestial object;
a docking station configured to receive the body;
a charging port positioned on the body and a reciprocal charging port positioned on the docking station, configured to charge the electronic components of the body;
a rotating platform positioned on the docking station, configured to rotate the body to simulate the rotation of a celestial object; and
a speaker integrated into the body, configured to produce an audio related to the celestial object.

14. The planetary learning device of claim 13, wherein the docking station is comprised of a solar panel.

15. The planetary learning device of claim 13, wherein the charging port is comprised of a USB-C, a lightning, or a wireless induction charging port.

16. The planetary learning device of claim 13, wherein the reciprocal charging port is comprised of a USB-C, a lightning, or a wireless induction charging port.

17. The planetary learning device of claim 13, wherein the body is comprised of a vibration motor.

18. The planetary learning device of claim 13, wherein the platform is rotated by a motor.

19. The planetary learning device of claim 13, wherein the body is comprised of a phosphorescent material.

20. The planetary learning device of claim 13, wherein the celestial object is comprised of a planet, a moon, a star, or an exoplanet.
